(19) United States
(12) Patent Application Publication
(10) Pub. No.: US 2023/0150108 A1
(43) Pub. Date: May 18, 2023

(54) ROTARY TOOL, ROTARY TOOL STAND, AND ROTARY TOOL INCLUDING ROTARY TOOL STAND

(71) Applicant: MAKITA CORPORATION, Anjo-shi (JP)

(72) Inventors: Yoshihiro ITO, Anjo-shi (JP); Hidenori NAGASAKA, Anjo-shi (JP)

(73) Assignee: MAKITA CORPORATION, Anjo-shi (JP)

(21) Appl. No.: 17/949,652

(22) Filed: Sep. 21, 2022

(30) Foreign Application Priority Data
Nov. 18, 2021 (JP) 2021-188101

(51) Int. Cl. B25H 1/00; B23B 45/00

(52) U.S. Cl. CPC B25H 1/0042; B23B 45/003

(57) ABSTRACT

A rotary tool allows easy attachment and detachment of the rotary tool stand. A driver drill includes a motor, a housing accommodating the motor, a tip tool holder rotatable by the motor, and a connecting member held on the housing. The connecting member has at least one connecting hole through which a pole is placeable. The pole extends from a base included in a rotary tool stand. The base is placeable on a workpiece.

### CROSS-REFERENCE TO RELATED APPLICATIONS

This application claims the benefit of priority to Japanese Patent Application No. 2021-188101, filed on Nov. 18, 2021, the entire contents of which are hereby incorporated by reference.

### BACKGROUND

### 1. Technical Field

The present disclosure relates to a rotary tool such as a driver drill, a rotary tool stand to support the rotary tool, and a rotary tool including a rotary tool stand.

### 2. Description of the Background

In an operation such as drilling using a rotary tool such as a driver drill, a rotary tool stand may be used. An example rotary tool stand described in Japanese Unexamined Patent Application Publication No. 2002-160110 includes a base placeable on a workpiece, a strut standing upward from the base, and a drill clamp attached to the strut in a vertically movable manner. The drill clamp can receive a body of a rotary tool, such as an electric drill, fastened to it with bolts. In response to a vertical operation on an operation lever included in the drill clamp, the rotary tool is vertically movable together with the drill clamp.

### BRIEF SUMMARY

A known rotary tool stand uses a drill clamp to connect a rotary tool. This increases the weight of the rotary tool stand, causing poor handling. Such a rotary tool stand also takes labor and time for attachment or detachment of the rotary tool, possibly deteriorating workability.

One or more aspects of the present disclosure are directed to a rotary tool that allows easy attachment and detachment of a rotary tool stand, a rotary tool stand that allows easy attachment and detachment of the rotary tool and weighs less, and a rotary tool including a rotary tool stand that allows easy attachment and detachment between the rotary tool and the rotary tool stand and weighs less.

A first aspect of the present disclosure provides a rotary tool, including:

a motor;

a housing accommodating the motor;

a tip tool holder rotatable by the motor; and

a connecting member held on the housing, the connecting member having at least one connecting hole through which a pole is placeable, the pole extending from a base included in a rotary tool stand, the base being placeable on a workpiece.

A second aspect of the present disclosure provides a rotary tool stand, including:

a base placeable on a workpiece; and

a pole extending from the base, the pole being placeable through the at least one connecting hole in the rotary tool.

A third aspect of the present disclosure provides a rotary tool including a rotary tool stand, the rotary tool including:

the rotary tool;

a base placeable on a workpiece; and

a pole extending from the base, the pole being placeable through the at least one connecting hole in the rotary tool.

A fourth aspect of the present disclosure provides a rotary tool, including:

a motor;

a spindle rotatable by the motor; and

a housing accommodating the motor, the housing including an engaging portion engageable with or disengageable from a receiving portion located in a tip tool holder couplable to the spindle, the tip tool holder being included in a rotary tool stand and placeable on a workpiece.

A fifth aspect of the present disclosure provides a rotary tool stand, including:

a base placeable on a workpiece; and

a tip tool holder connected to the base, the tip tool holder including

a joint couplable to the spindle in the rotary tool, and

a receiving portion engageable with or disengageable from the engaging portion in the rotary tool.

A sixth aspect of the present disclosure provides a rotary tool including a rotary tool stand, the rotary tool including:

the rotary tool;

a base placeable on a workpiece; and

a tip tool holder connected to the base, the tip tool holder including
a joint couplable to the spindle in the rotary tool, and
the receiving portion engageable with or disengageable from the engaging portion in the rotary tool.

The rotary tool according to the above aspects of the present disclosure allows easy attachment and detachment of the rotary tool stand, thus improving workability.

The rotary tool stand according to the above aspects of the present disclosure allows easy attachment and detachment of the rotary tool and weighs less.

The rotary tool including a rotary tool stand according to the above aspects of the present disclosure allows easy attachment and detachment between the rotary tool and the rotary tool stand, thus improves workability and weighs less.

### BRIEF DESCRIPTION OF DRAWINGS

FIG. 1 is a perspective view of a rechargeable driver drill including a drill stand according to a first embodiment.

FIG. 2 is an exploded perspective view of the rechargeable driver drill including the drill stand according to the first embodiment.

FIG. 3 is a side view of the rechargeable driver drill including the drill stand according to the first embodiment.

FIG. 4 is a cross-sectional view taken along line A-A in FIG. 3.

FIG. 5 is a perspective view of a rechargeable driver drill including a drill stand according to a second embodiment.

FIG. 6 is a perspective view of the rechargeable driver drill according to the second embodiment as viewed from below.

FIG. 7 is an exploded perspective view of the drill stand according to the second embodiment as viewed from above.

FIG. 8 is a side view of the rechargeable driver drill including the drill stand according to the second embodiment.

FIG. 9 is a cross-sectional view taken along line B-B in FIG. 8.

### DETAILED DESCRIPTION

First Embodiment

Embodiments of the present disclosure will now be described with reference to the drawings.

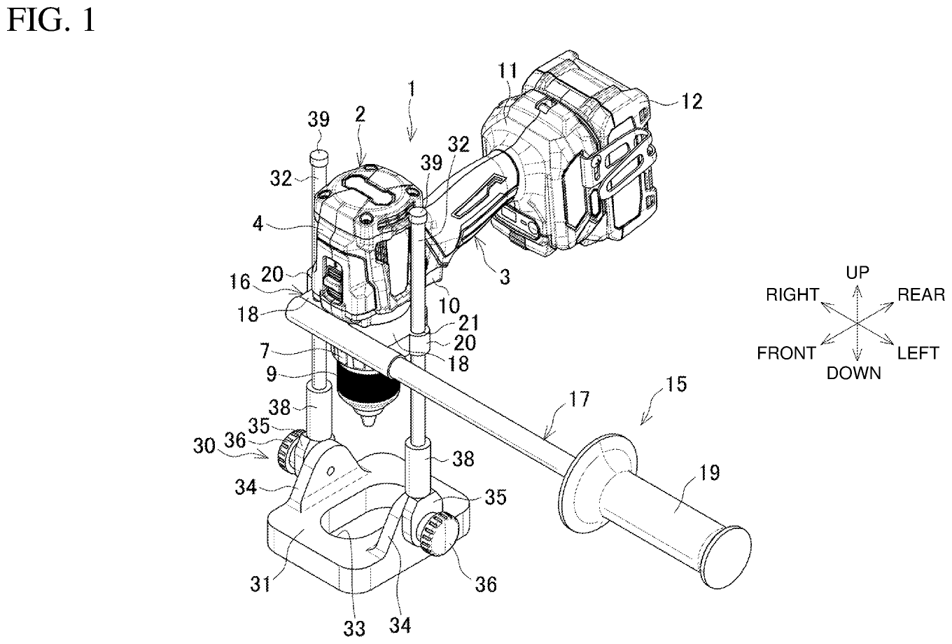

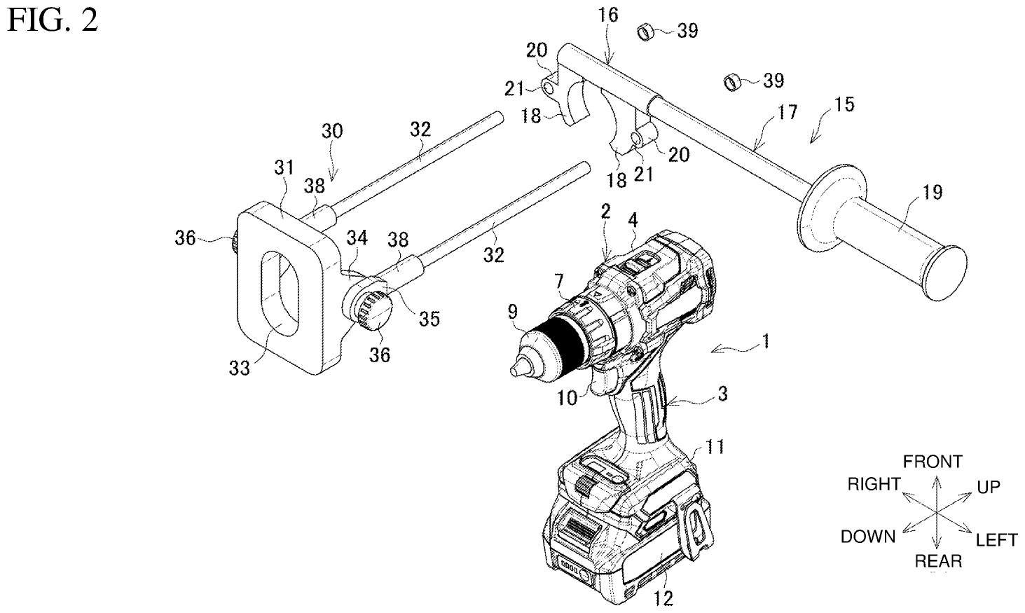

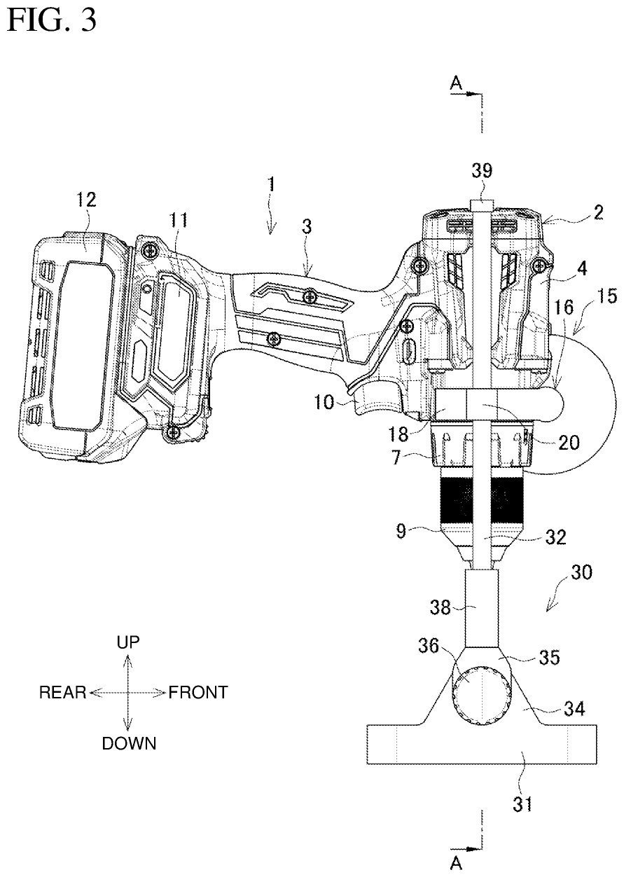

FIG. 1 is a perspective view of a rechargeable driver drill (hereafter, simply a driver drill) 1 as an example of a rotary tool. The driver drill 1 includes a drill stand 30 as an example of a rotary tool stand, which is connected to the driver drill 1. FIG. 2 is an exploded perspective view of the driver drill 1 including the drill stand 30. FIG. 3 is a side view of the driver drill 1 including the drill stand 30. The front, rear, right, left, upper, and lower directions are hereafter defined with respect to the driver drill 1 facing downward with the drill stand 30 including a base 31 at the bottom.

The driver drill 1 includes a body 2 and a grip 3. The body 2 extends vertically.

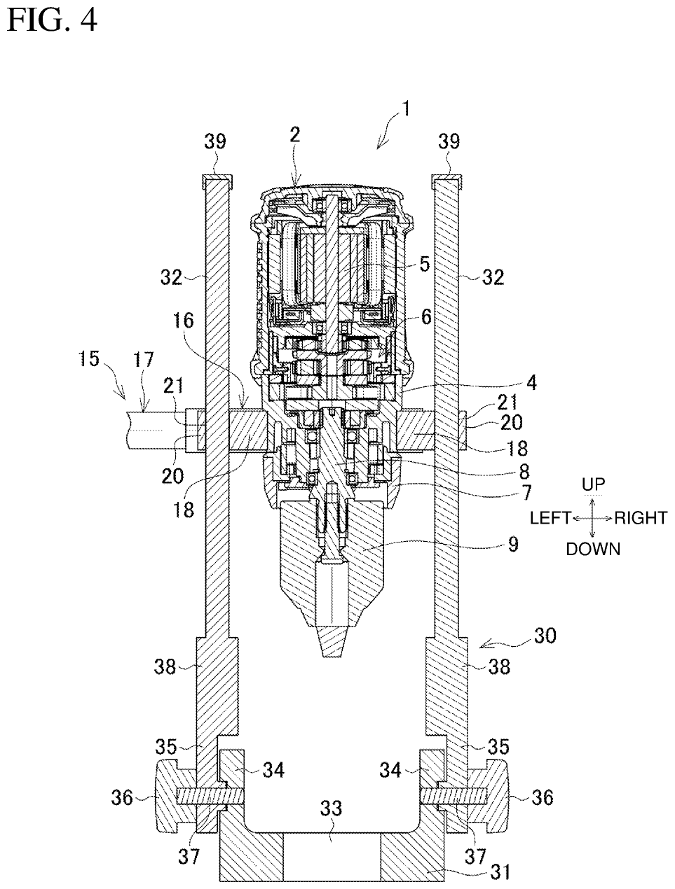

The grip 3 extends rearward from the body 2. As shown in FIG. 4, the body 2 includes a cylindrical housing 4 accommodating a motor 5 and an output unit 6. The housing 4 includes, at its lower end, an operation ring 7 for switching a clutch. The output unit 6 includes a spindle 8 protruding downward from the lower end of the housing 4. A drill chuck 9 is integrally attached to the lower end of the spindle 8.

The grip 3 is integral with the housing 4. The grip 3 includes a switch (not shown). The switch includes a trigger 10 protruding downward from the grip 3. A battery mount 11 is located at the rear of the grip 3. The battery mount 11 receives a battery pack 12.

A side handle 15 is attached to the body 2. The side handle 15 includes a holder 16 and a rod 17. The holder 16 includes a pair of right and left holding tabs 18. The holding tabs 18 hold the housing 4, above the operation ring 7, to connect the holder 16 and the housing 4 together. The rod 17 extends leftward from the holder 16. A grip 19 is located at the left end of the rod 17.

The holder 16 includes a pair of extensions 20 at its right and left ends. Each extension 20 has a connecting hole 21 vertically extending through it. The connecting hole 21 has a circular cross section. The connecting holes 21 are at laterally symmetrical positions about an axis of the body 2.

The drill stand 30 includes the base 31 and a pair of poles 32. The base 31 is rectangular as viewed in plan. The base 31 has, at its center, a through-hole 33 elongated in the front-rear direction. The base 31 includes a pair of holding plates 34 extending upward from its upper right and upper left surfaces.

Each pole 32 includes a connecting plate 35 at its lower end. The pole 32 has a circular cross section in its upper portion excluding the lower end. The connecting plates 35 are located laterally outside the holding plates 34. The connecting plate 35 are connected to the corresponding holding plates 34 with knob screws 36 laterally from outside. Thus, each pole 32 is rotatable about a threaded portion 37 of the knob screw 36 in the front-rear direction in response to the corresponding knob screw 36 being loosened. The pole 32 can be fastened at an intended angle in response to the knob screw 36 being tightened. The pole 32 receives a cylindrical stopper 38 above the connecting plate 35.

The interval between the right and left poles 32 is the same as the interval between the right and left connecting holes 21 in the side handle 15. With the poles 32 placed through the connecting holes 21 from below, the side handle 15 and the driver drill 1 are vertically movable along the poles 32. Each pole 32 receives a cap 39 on its distal end. The cap 39 prevents the side handle 15 from slipping off upward.

In the driver drill 1 and the drill stand 30 according to the present embodiment, the poles 32 in the drill stand 30 are placed through the connecting holes 21 in the side handle 15 and receive the caps 39 at their distal ends. The drill stand 30 is thus attached to the side handle 15 in a manner vertically movable relative to the side handle 15 along the poles 32. The holder 16 in the side handle 15 is in contact with the stoppers 38 at the lowermost position of the driver drill 1. The holder 16 is in contact with the caps 39 at the uppermost position of the driver drill 1.

To perform an operation such as drilling, an operator first places the base 31 in the drill stand 30 against a workpiece and aligns the through-hole 33 with a drilling target position.

The operator then fastens the poles 32 at an intended angle with the knob screws 36. This angle defines the drilling direction. In this state, the operator presses the trigger 10 while holding the grip 3 in the driver drill 1 and the grip 19 in the side handle 15. This drives the motor 5 to rotate the spindle 8 in the output unit 6, rotating the drill chuck 9 together with the spindle 8. In this state, the operator pushes the driver drill 1 downward together with the side handle 15 to cause the driver drill 1 to slide downward along the poles 32. This allows a drill bit attached to the drill chuck 9 to, for example, drill a workpiece. Upon completion of the operation, the operator pulls the driver drill 1 upward to cause the driver drill 1 to slide upward along the poles 32 together with the side handle 15. The driver drill 1 is then separate from the workpiece.

When not using the drill stand 30, the operator removes the caps 39 from the poles 32, and then removes the poles 32 from the connecting holes 21 in the side handle 15. This detaches the drill stand 30 from the side handle 15.

The driver drill 1 (an example of a rotary tool) according to the first embodiment includes the motor 5, the housing 4 accommodating the motor 5, the drill chuck 9 (an example of a tip tool holder) rotatable by the motor 5, and the side handle 15 (an example of a connecting member) held on the housing 4. The side handle 15 has the connecting holes 21. The drill stand 30 includes the base 31 placeable on a workpiece, and the poles 32 extending from the base 31. The poles 32 are placeable through the connecting holes 21. This structure allows easy attachment and detachment of the drill stand 30 using the connecting holes 21 and the poles 32, thus improving workability.

The drill stand 30 includes multiple poles 32. The side handle 15 has multiple connecting holes 21.

This allows stable connection between the driver drill 1 and the drill stand 30. This also allows stable movement of the driver drill 1 relative to the poles 32.

A connecting member is the side handle 15 to hold the housing 4.

An existing side handle 15 can be used to connect the drill stand 30, reducing the number of components.

The drill stand 30 includes a pair of poles 32. The holder 16 in the side handle 15 to hold the housing 4 has a pair of connecting holes 21.

This allows well-balanced connection between the side handle 15 and the poles 32.

The drill stand 30 (an example of a rotary tool stand) according to the first embodiment includes the base 31 placeable on a workpiece, and the poles 32 extending from the base 31. The poles 32 are placeable through the connecting holes 21 in the driver drill 1.

This structure allows easy attachment and detachment of the driver drill 1 simply by placing or removing the poles 32 through or from the connecting holes 21. This structure eliminates separate components such as a known drill clamp and thus weighs less.

The poles 32 each have an angle adjustable relative to the base 31.

This allows easy handling with the angle suitably adjusted for an operation.

In the driver drill 1 including the drill stand 30 (an example of a rotary tool including a rotary tool stand) according to the first embodiment, the driver drill 1 is movable along the poles 32 in the drill stand 30. The poles 32 are placed through the connecting holes 21 in the driver drill 1.

This structure allows easy attachment and detachment between the driver drill 1 and the drill stand 30, thus improving workability. The driver drill 1 including the drill stand 30 also weighs less and is thus easy to handle.

The first embodiment may be modified as described below.

The poles and the connecting holes each may have a cross section other than a circular cross section. For example, the poles and the connecting holes each may have a rectangular or a hexagonal cross section. The connecting holes may be located at different positions as appropriate.

The connecting holes may receive bearings on their inner peripheral surfaces to support the corresponding poles, rather than being simple through-holes.

More or fewer poles and more or fewer connecting holes than in the examples may be used as appropriate. For example, one pole and one connecting hole may support the side handle in a cantilevered manner.

The stoppers attached to the poles may be eliminated.

The angles of the poles may not be adjustable. The base may have a different shape as appropriate.

The side handle is not limited to the shape in the above example. For example, the holder may be a ring rather than the pair of tabs. The rod may be a separate component attachable to and detachable from the holder.

The connecting member having the connecting holes is not limited to the side handle in the above example. For example, an adapter for collecting dust, or an adapter for adjusting the depth to which processing is performed may be used as the connecting member.

The housing with the connecting holes in it may also be used as the connecting member.

A connecting member without any additional function, unlike the side handle, may be used. The connecting member may have connecting holes to be used for fastening to the housing.

### Second Embodiment

A second embodiment will now be described. The same components as in the first embodiment are given the same reference numerals and will not be described repeatedly.

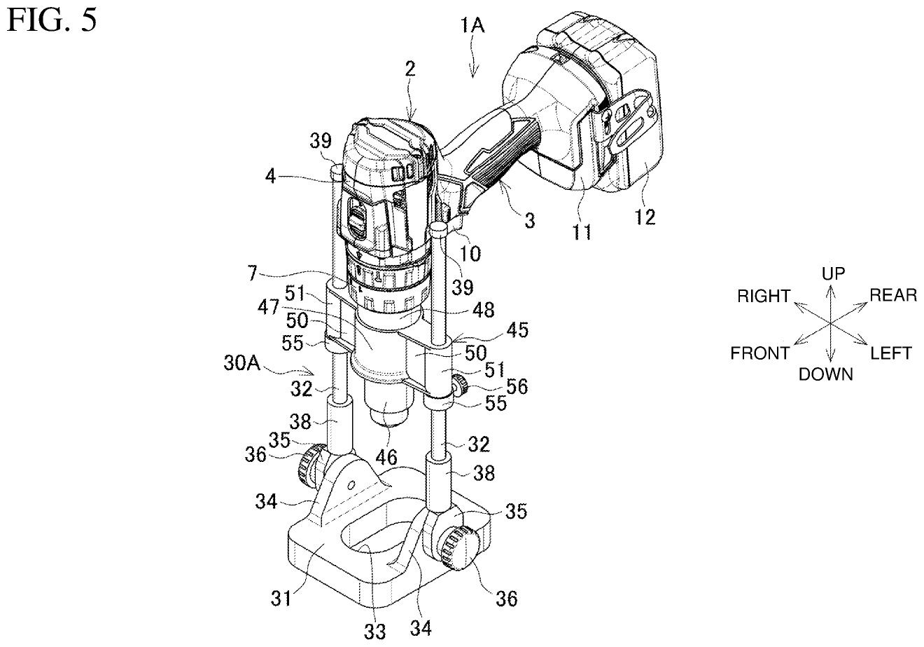

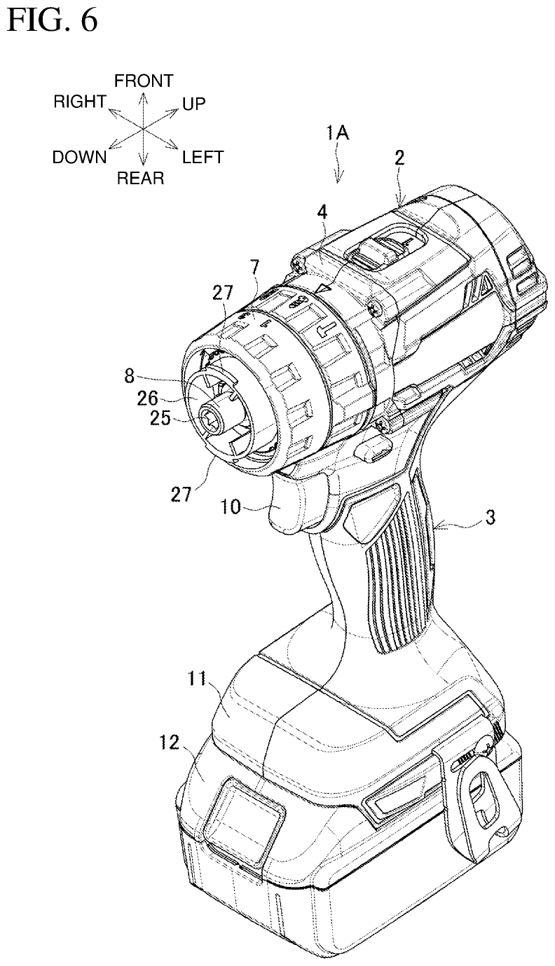

FIG. 5 is a perspective view of a driver drill 1A including a drill stand 30A. As shown in FIG. 6, the driver drill 1A has a hexagonal hole 25 at the lower end of the spindle 8. The spindle 8 receives no drill chuck at its lower end. The housing 4 includes, at its lower end, an upper cylindrical portion 26. The upper cylindrical portion 26 opens downward with the spindle 8 at its center. The upper cylindrical portion 26 has a pair of outer engagement tabs 27 on its lower outer circumferential surface. The outer engagement tabs 27 are located point-symmetric to each other about the axis of the upper cylindrical portion 26. Each outer engagement tab 27 extends radially outward from the upper cylindrical portion 26, and extends in the circumferential direction of the upper cylindrical portion 26.

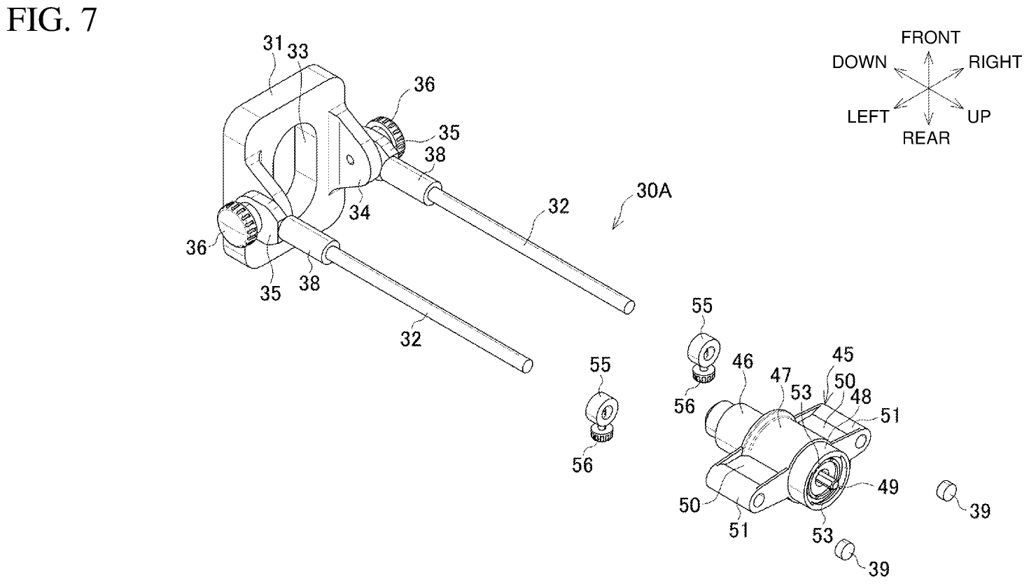

As shown in FIG. 7, the drill stand 30A includes a chuck unit 45. The chuck unit 45 includes a drill chuck 46, a holding cylinder 47, and a lower cylindrical portion 48. The drill chuck 46 can receive, for example, a drill bit at its lower end, similarly to the drill chuck 9 in the first embodiment. The drill chuck 46 is integral with a hexagonal shaft 49 protruding upward from its center.

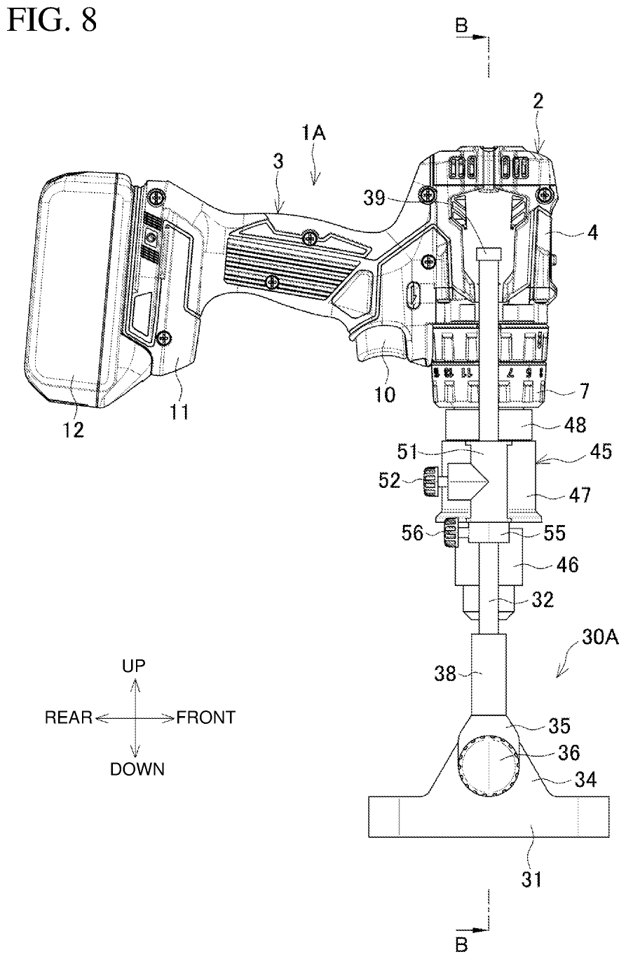

The holding cylinder 47 is located between the poles 32. The holding cylinder 47 holds, at its lateral middle, the drill chuck 46 in a rotatable manner. The drill chuck 46 faces downward. The holding cylinder 47 includes, at its right and left, a pair of wings 50 extending laterally. The wings 50 are each integral with, at their right or left end, a guide cylinder 51. The poles 32 extend through the guide cylinders 51. As shown in FIG. 8, the right guide cylinder 51 receives a knob screw 52 screwed from the rear. The chuck unit 45 can be fastened at any position along the poles 32 with the knob screw 52 being tightened.

The lower cylindrical portion 48 at the upper end of the holding cylinder 47 is rotatable about the hexagonal shaft 49. The lower cylindrical portion 48 has an inner diameter large enough to receive the upper cylindrical portion 26 of the driver drill 1A fitted in it, including the outer engagement tabs 27. The lower cylindrical portion 48 has a pair of inner engagement tabs 53 on its upper inner circumferential surface. The inner engagement tabs 53 are located point-symmetric to each other about the axis of the lower cylindrical portion 48. Each inner engagement tab 53 extends radially inward from the lower cylindrical portion 48, and extends in the circumferential direction of the lower cylindrical portion 48. With the inner engagement tabs 53 circumferentially aligned with the outer engagement tabs 27 on the upper cylindrical portion 26, the inner engagement tabs 53 are vertically in contact with the outer engagement tabs 27. This obstructs fitting of the upper cylindrical portion 26 into the lower cylindrical portions 48. With the inner engagement tabs 53 circumferentially displaced from the outer engagement tabs 27, the inner engagement tabs 53 on the lower cylindrical portion 48 receive the outer engagement tabs 27 between them. This fits the upper cylindrical portion 26 in the lower cylindrical portion 48.

The right and left poles 32 receive a pair of stopper rings 55 between the stoppers 38 and the chuck unit 45. Each stopper ring 55 receives a knob screw 56 screwed from the rear. The stopper ring 55 can be fastened at any position along the pole 32 with the knob screw 56 being tightened. The positions of the stopper rings 55 can be vertically adjusted to determine the lowermost position at which the chuck unit 45 comes in contact with the stopper rings 55.

To connect the driver drill 1A to the drill stand 30A in the present embodiment, the knob screw 52 in the guide cylinder 51 and the knob screws 56 in the stopper rings 55 are tightened first. This restricts vertical movement of the chuck unit 45.

The lower cylindrical portion 48 of the chuck unit 45 is then rotated to a position at which the outer engagement tabs 27 and the inner engagement tabs 53 are not in contact with each other. In this state, the upper cylindrical portion 26 of the driver drill 1A is fitted in the lower cylindrical portion 48. At the same time, the hexagonal shaft 49 in the drill chuck 46 is fitted in the hexagonal hole 25 in the spindle 8 to couple the drill chuck 46 and the spindle 8 together.

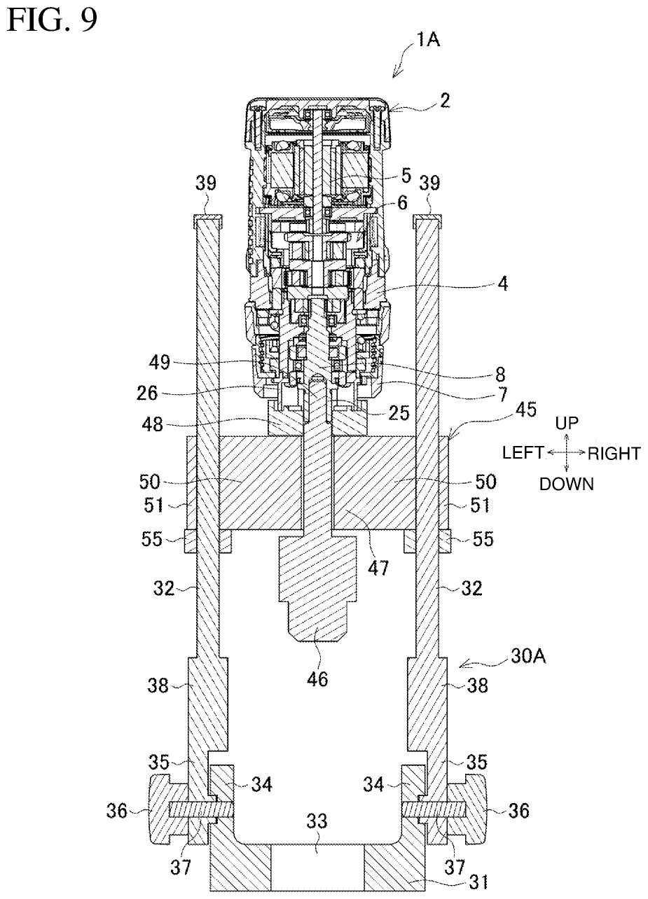

The lower cylindrical portion 48 is then rotated to a position at which the outer engagement tabs 27 and the inner engagement tabs 53 are in contact with each other. As shown in FIG. 9, the upper cylindrical portion 26 and the lower cylindrical portion 48 are coaxially bayonet-connected to each other, and are prevented from slipping off from each other. Thus, the drill stand 30A is attached to the housing 4 with the chuck unit 45 in a manner vertically movable relative to the housing 4.

To perform an operation such as drilling, an operator first places the base 31 in the drill stand 30A against a workpiece and aligns the through-hole 33 with a drilling target position. The operator then fastens the poles 32 at an intended angle with the knob screws 36. The operator then loosens the knob screw 52 in the guide cylinder 51 and the knob screws 56 in the stopper rings 55. In this state, the operator presses the trigger 10 while holding the grip 3 in the driver drill 1A. This drives the motor 5 to rotate the spindle 8, rotating the drill chuck 46 together with the spindle 8 with the hexagonal shaft 49 between them. In this state, the operator pushes the driver drill 1A together with the chuck unit 45 toward the workpiece to cause the chuck unit 45 to slide downward along the poles 32. This allows a drill bit attached to the drill chuck 46 to, for example, drill the workpiece. Upon completion of the operation, the operator pulls the driver drill 1A upward to cause the chuck unit 45 to slide upward along the poles 32. The driver drill 1A is then separate from the workpiece.

When not using the drill stand 30A, the operator rotates the lower cylindrical portion 48 to release the bayonet connection between the lower cylindrical portion 48 and the upper cylindrical portion 26. The operator then removes the upper cylindrical portion 26 of the housing 4 from the lower cylindrical portion 48 and detaches the spindle 8 from the hexagonal shaft 49. This detaches the drill stand 30A from the driver drill 1A.

The driver drill 1A (an example of a rotary tool) according to the second embodiment includes the motor 5, the housing 4 accommodating the motor 5, and the spindle 8 rotatable by the motor 5. The housing 4 includes the outer engagement tabs 27 (examples of an engaging portion) engageable with or disengageable from the inner engagement tabs 53 (examples of a receiving portion) located in the chuck unit 45 (an example of a tip tool holder). The drill stand 30A includes the base 31 placeable on a workpiece, and the chuck unit 45 connected to the base 31 and couplable to the spindle 8.

This structure allows easy attachment and detachment of the drill stand 30A using the outer engagement tabs 27 and the inner engagement tabs 53, thus improving workability.

The outer engagement tabs 27 are engageable with or disengageable from the inner engagement tabs 53 through the bayonet connection.

Thus, the housing 4 can be easily engaged with or disengaged from the chuck unit 45 with a single operation.

The housing 4 includes the upper cylindrical portion 26 (an example of a first cylindrical portion). The outer engagement tabs 27 are located in the upper cylindrical portion 26. The chuck unit 45 includes the lower cylindrical portion 48 (an example of a second cylindrical portion) fittable with the upper cylindrical portion 26. The inner engagement tabs 53 are located in the lower cylindrical portion 48. With the upper cylindrical portion 26 being fitted in the lower cylindrical portion 48, the lower cylindrical portion 48 is rotated to engage or disengage the outer engagement tabs 27 with or from the inner engagement tabs 53.

This allows the stable bayonet connection, together with the cylindrical portions 26 and 48 fitted to each other.

The drill stand 30A (an example of a rotary tool stand) according to the second embodiment includes the base 31 placeable on a workpiece, and the chuck unit 45 connected to the base 31. The chuck unit 45 includes the hexagonal shaft 49 (an example of a joint) couplable to the spindle 8 in the driver drill 1A, and the inner engagement tabs 53 engageable with or disengageable from the outer engagement tabs 27 located in the housing 4 in the driver drill 1A.

This structure allows easy attachment and detachment of the driver drill 1A simply by engaging or disengaging the inner engagement tabs 53 with or from the outer engagement tabs 27. This structure eliminates separate components such as a known drill clamp and thus weighs less.

The poles 32 are connected to the base 31. The chuck unit 45 is movable along the poles 32.

The driver drill 1A connected to the chuck unit 45 is thus easily movable together with the chuck unit 45.

The multiple poles 32 are connected to the base 31. The chuck unit 45 is movable along the multiple poles 32.

The driver drill 1A can thus move stably relative to the poles 32.

The pair of poles 32 are connected to the base 31. The chuck unit 45 is located between the pair of poles 32.

The driver drill 1A connected to the chuck unit 45 is thus supported in a well-balanced manner together with the chuck unit 45 and is stably movable.

The tip tool holder includes the drill chuck 46. The joint couplable to the spindle 8 is the hexagonal shaft 49 (an example of a shaft) rotatable together with the drill chuck 46.

The drill chuck 46 can thus be easily coupled to the spindle 8.

In the driver drill 1A including the drill stand 30A (an example of rotary tool including a rotary tool stand) according to the second embodiment, the outer engagement tabs 27 in the driver drill 1A are engaged with the inner engagement tabs 53 in the drill stand 30A, and the spindle 8 in the driver drill 1A is couplable to the hexagonal shaft 49 in the drill stand 30A.

This structure allows easy attachment and detachment between the driver drill 1A and the drill stand 30A, thus improving workability. The driver drill 1A including the drill stand 30A also weighs less and is thus easy to handle.

The second embodiment may be modified as described below.

The fitting relationship between the upper cylindrical portion and the lower cylindrical portion may be reversed with respect to the fitting relationship described above. In other words, the lower cylindrical portion may be fitted in the upper cylindrical portion. The positional relationship between the outer engagement tabs and the inner engagement tabs may be changed in accordance with this fitting relationship. The upper cylindrical portion, rather than the lower cylindrical portion, may be rotatable.

The shape and the circumferential length of each engagement tab, and the number of the engagement tabs may be changed as appropriate.

The engaging portion and the receiving portion are not limited to the engagement tabs in the above example. For example, the coupling between the engaging portion and the receiving portion may be bayonet connection using one of the engaging portion or the receiving portion as a projection and the other as an L-shaped groove or a slit to receive the projection.

The engagement between the engaging portion and the receiving portion may have a structure other than the bayonet connection.

The coupling between the spindle and the joint in the drill chuck is not limited to the coupling between the hexagonal hole and the hexagonal shaft in the above example. For example, the hexagonal hole and the hexagonal shaft may be reversely located. The spindle and the joint may include cam teeth, which engage with each other in the rotation direction.

The drill stand may be modified as appropriate.

For example, the chuck unit may be fastened with the right and left knob screws. The knob screws may be eliminated.

The drill chuck in the chuck unit may be attachable to and detachable from the chuck unit. In this case as well, for example, the holding cylinder and the chuck unit may be bayonet-connected to each other to be attachable with and detachable from each other with a single operation. The detached drill chuck may be bayonet-connected to the driver drill to be usable.

Either of the stopper rings alone may be used. The stopper rings may be eliminated.

The pole may have a cross section in any shape as appropriate as in the first embodiment.

A single pole may be used. The angles of the poles may not be adjustable.

The stoppers attached to the poles may be eliminated. The base may be shaped differently as appropriate.

In the above embodiments, the rotary tool is not limited to the driver drill. The present disclosure is applicable to, for example, an electric drill, a vibration drill, a vibration driver drill, and other rotary tools.

In the rotary tool, the grip may not protrude orthogonally from the body. In the rotary tool, the grip may be, for example, linearly connected to the body.

The rotary tool may be powered by alternating current (AC), or utility power, rather than by a rechargeable battery.

In each embodiment, the drill stand is used with the base placed at the bottom. However, in the present disclosure, the drill stand may face horizontally with the base placed on a wall, or may face upward with the base placed on, for example, a ceiling.

### REFERENCE SIGNS LIST

1, 1A rechargeable driver drill
2 body
3 grip
4 housing
5 motor
6 output unit
8 spindle
9, 46 drill chuck
15 side handle
16 holder
17 rod
18 holding tab
20 extension
21 connecting hole
25 hexagonal hole
26 upper cylindrical portion
27 outer engagement tab
30, 30A drill stand
31 base
32 pole
36, 52, 56 knob screw
45 chuck unit
47 holding cylinder
48 lower cylindrical portion
49 hexagonal shaft
53 inner engagement tab

What is claimed is:

1. A rotary tool, comprising:
a motor;
a housing accommodating the motor;
a tip tool holder rotatable by the motor; and
a connecting member held on the housing, the connecting member having at least one connecting hole through which a pole is placeable, the pole extending from a base included in a rotary tool stand, the base being placeable on a workpiece.

2. The rotary tool according to claim 1, wherein
the connecting member has the at least one connecting hole being a plurality of connecting holes through which a plurality of the poles in the rotary tool stand are placeable.

3. The rotary tool according to claim 1, wherein
the connecting member includes a side handle holding the housing.

4. The rotary tool according to claim 3, wherein
the side handle includes a holder holding the housing, and
the holder has the at least one connecting hole being a pair of connecting holes through which a pair of the poles in the rotary tool stand are placeable.

5. A rotary tool stand, comprising:
a base placeable on a workpiece; and
a pole extending from the base, the pole being placeable through the at least one connecting hole in the rotary tool according to claim 1.

6. The rotary tool stand according to claim 5, wherein
the pole has an angle adjustable relative to the base.

7. A rotary tool including a rotary tool stand, the rotary tool comprising:
the rotary tool according to claim 1;
a base placeable on a workpiece; and
a pole extending from the base, the pole being placeable through the at least one connecting hole in the rotary tool.

8. A rotary tool, comprising:
a motor;
a spindle rotatable by the motor; and
a housing accommodating the motor, the housing including an engaging portion engageable with or disengageable from a receiving portion located in a tip tool holder couplable to the spindle, the tip tool holder being included in a rotary tool stand and placeable on a workpiece.

9. The rotary tool according to claim 8, wherein
the engaging portion is engageable with or disengageable from the receiving portion through bayonet connection.

10. The rotary tool according to claim 8, wherein
the housing includes a first cylindrical portion,
the engaging portion is located in the first cylindrical portion,
the tip tool holder includes a second cylindrical portion fittable with the first cylindrical portion,
the receiving portion is located in the second cylindrical portion, and
with the first cylindrical portion being fitted in the second cylindrical portion, the first cylindrical portion or the second cylindrical portion is rotated to engage or disengage the engaging portion with or from the receiving portion.

11. A rotary tool stand, comprising:
a base placeable on a workpiece; and
a tip tool holder connected to the base, the tip tool holder including
a joint couplable to the spindle in the rotary tool according to claim 8, and
a receiving portion engageable with or disengageable from the engaging portion in the rotary tool.

12. The rotary tool stand according to claim 11, further comprising:
at least one pole connected to the base,
wherein the tip tool holder is movable along the at least one pole.

13. The rotary tool stand according to claim 12, wherein
the at least one pole includes a plurality of the poles connected to the base, and
the tip tool holder is movable along the plurality of poles.

14. The rotary tool stand according to claim 13, wherein
the rotary tool stand includes a pair of the poles connected to the base, and
the tip tool holder is located between the pair of poles.

15. The rotary tool stand according to claim 11, wherein
the tip tool holder includes a drill chuck, and
the joint couplable to the spindle includes a shaft rotatable together with the drill chuck.

16. A rotary tool including a rotary tool stand, the rotary tool comprising:
the rotary tool according to claim 8;
a base placeable on a workpiece; and
a tip tool holder connected to the base, the tip tool holder including
a joint couplable to the spindle in the rotary tool, and
the receiving portion engageable with or disengageable from the engaging portion in the rotary tool.

17. The rotary tool according to claim 2, wherein
the connecting member includes a side handle holding the housing.

18. The rotary tool according to claim 9, wherein
the housing includes a first cylindrical portion,
the engaging portion is located in the first cylindrical portion,
the tip tool holder includes a second cylindrical portion fittable with the first cylindrical portion,
the receiving portion is located in the second cylindrical portion, and
with the first cylindrical portion being fitted in the second cylindrical portion, the first cylindrical portion or the second cylindrical portion is rotated to engage or disengage the engaging portion with or from the receiving portion.

19. The rotary tool stand according to claim 12, wherein
the tip tool holder includes a drill chuck, and
the joint couplable to the spindle includes a shaft rotatable together with the drill chuck.

20. The rotary tool stand according to claim 13, wherein
the tip tool holder includes a drill chuck, and
the joint couplable to the spindle includes a shaft rotatable together with the drill chuck.
